(19) United States
(12) Patent Application Publication
(10) Pub. No.: US 2026/0007287 A1
(43) Pub. Date: Jan. 8, 2026

(54) VACUUM CLEANER

(71) Applicant: Miele & Cie. KG, Guetersloh (DE)

(72) Inventors: Matthias HOLLENHORST, Lippstadt (DE); Ben SIEGHOLT, Koeln (DE); Felix RUETTEN, Bielefeld (DE)

(21) Appl. No.: 19/101,063

(22) PCT Filed: Jul. 26, 2023
(86) PCT No.: PCT/EP2023/070708

§ 371 Date: Feb. 4, 2025

(30) Foreign Application Priority Data
Aug. 17, 2022 (BE) BE2022/5644

(51) Int. Cl. A47L 9/30; A47L 9/24; F21V 8/00

(52) U.S. Cl. CPC A47L 9/30; A47L 9/242; A47L 9/248; G02B 6/0096

(57) ABSTRACT

A vacuum cleaner with a hand-held part, which has a light source and a light guide, and at least one accessory which is able to be coupled to the hand-held part and has a further light guide. The light guide has a lens-shaped surface such that, during operation, it functions as a light output body when the hand-held part and the at least one accessory are uncoupled, and functions as a light coupling site for the further light guide when the hand-held part and the at least one accessory are coupled.

### RELATED APPLICATIONS

The present disclosure claims priority to and the benefit of PCT Application PCT/EP2023/070708, filed on Jul. 26, 2023, which claims priority to and the benefit of Belgium Application BE2022/5644, filed on Aug. 17, 2022, the entire contents of both of which are incorporated herein by reference.

### TECHNICAL FIELD

The disclosure relates to a vacuum cleaner. In particular, the disclosure relates to a vacuum cleaner with a hand-held part and an accessory.

### BACKGROUND

Using a vacuum cleaner to vacuum a poorly lit area is made significantly easier by illuminating the area to be cleaned. Vacuum cleaners may therefore have a light source placed in the hand-held part. We have found that vacuum cleaners with a light source in the hand-held part illuminate the area to be cleaned significantly worse when the accessory is attached, since the distance to the area to be cleaned becomes greater.

### SUMMARY

The present disclosure provides a vacuum cleaner which is designed to achieve a consistent quality of illumination, regardless of whether, how many and which accessories are coupled to the hand-held part or to one another. In addition, the vacuum cleaner is to be cost-effective.

The advantages achievable with the disclosure include cost advantages in addition to a consistent quality of illumination regardless of whether one or more accessories are used with the hand-held part. Since additional light sources in accessories are not required, the manufacturing costs are reduced.

The disclosure relates to a vacuum cleaner with a hand-held part, which has a light source and a light guide, and at least one accessory which is able to be coupled to the hand-held part and has a further light guide, wherein the light guide has a lens-shaped surface such that, during operation, it functions as a light output body when the hand-held part and the at least one accessory are uncoupled, and functions as a light coupling site for the further light guide when the hand-held part and the at least one accessory are coupled.

The vacuum cleaner is preferably designed as a hand-held device, more preferably as a hand-held vacuum cleaner or an upright, pole or stick vacuum cleaner. Preferably, the vacuum cleaner is designed as a cordless vacuum cleaner, i.e., it has an accumulator or battery. The hand-held part is designed to be gripped by the user during operation and preferably has a handle. The at least one accessory is preferably designed as a nozzle such as a suction nozzle or a tube such as an extension tube. The hand-held part and the at least one accessory are designed such that they can be coupled to one another when the user wants to use the accessory. Preferably, the hand-held part and the at least one accessory are designed to be detachably coupled via a plug connection. However, the hand-held part is designed in such a way that it can be used independently as a vacuum cleaner so that it can also be used uncoupled from the at least one accessory or not coupled to the at least one accessory or non-coupled. Preferably, the hand-held part contains all the vacuum cleaner components required for the function of vacuuming. Alternatively, the hand-held part may be coupled to the vacuum cleaner components essential for functioning as a vacuum cleaner.

The vacuum cleaner comprises a light guide system which allows light generated in the hand-held part of the vacuum cleaner to be coupled out of the hand-held part when used without an accessory, and to be guided through and coupled out of one or more coupled accessories when the hand-held part is coupled to the at least one accessory. Preferably, the ends of the light guide of the hand-held part each have a lens-shaped surface so that the light guide transmits light as effectively as possible into the further light guide of the accessory coupled to the hand-held part, when the accessory is coupled to the hand-held part, and so that the light guide can couple out light such that the suction point is well illuminated for the user when no accessory is coupled to the hand-held part.

The illumination unit, which is placed in the hand-held part of the vacuum cleaner, comprises or more preferably consists substantially of two components, the light source and the light guide. The light guide has the task of capturing the light from the light source, bundling it and coupling it out again at the output surface in the direction of the suction region. In a preferred embodiment, the light guide has an incoupling optic and an outcoupling optic, which are each designed as lenses. These lenses represent the lens-shaped surface of the light guide. Two lenses are preferably integrally formed at the ends of the light guide to bundle and couple out the light. When the hand-held part is coupled to the at least one accessory, the illumination unit has the light source, integrated into the hand-held part, and the light guide system, consisting of the light guide and the further light guide. No additional light source is required in the accessory.

Preferably, the lenses of the light guide in the hand-held part are convex. This means that each of the lenses of the incoupling optic and the outcoupling optic is convex.

In a preferred embodiment, the lens of the outcoupling optic is inclined at its light output surface relative to an optical axis of the light guide at the predetermined angle. The predetermined angle is preferably in the range of 10 to 14°. The reason for this is that the light is not to exit symmetrically to the light guide, but at an angle to the optical axis of the light guide, which ensures optimal illumination of the suction region.

Preferably, the light guide has a circular or substantially circular cross section. Preferably, the light guide has a diameter and the lens of the outcoupling optic has a radius that corresponds to or substantially corresponds to the diameter. Preferably, the diameter and the radius are each in the range of 2 to 6 mm, more preferably 3 to 5 mm.

In a preferred embodiment, the lens of the incoupling optic is parabolic or spherical. The incoupling optic in the form of the lens is preferably designed as a convex surface which is either parabolic or spherical. The light source is preferably designed such that it is adapted thereto.

Preferably, the lens of the outcoupling optic is spherical. The outcoupling optic in the form of a lens is preferably designed as a convex surface which is spherical. More preferably, the outcoupling optic is designed as a convex, spherical lens with a radius in the range of 2 to 6 mm, more preferably 3 to 5 mm, which is inclined at a predetermined angle of 10 to 14° to the optical axis of the light guide. For example, if the lens of the outcoupling optic is inclined at the predetermined angle of 12° to the optical axis of the light guide, the optical axis of the light cone is inclined by approximately 18°.

In a preferred embodiment, the further light guide has a further incoupling optic and a further outcoupling optic, which are each designed as lenses. This provides a light interface between the light guide and the further light guide, which allows light to be transmitted from the light guide to the further light guide with as little loss as possible. This means that, at the end of the light path, i.e., for example, in the accessory which is coupled to the hand-held part and in which the further light guide is integrated, can be coupled out without casting a shadow and can illuminate the suction region homogeneously. The lens of the further incoupling optic is preferably designed as a negative form of the lens of the outcoupling optic, and the lens of the further outcoupling optic is preferably the same or substantially the same as the lens of the outcoupling optic of the light guide in the hand-held part. When the hand-held part and the at least one accessory are coupled, the ends of the light guide and of the further light guide are preferably brought very close together.

Preferably, a distance between the lens of the outcoupling optic and the lens of the further incoupling optic is less than 0.5 mm when the hand-held part is coupled to the at least one accessory. Preferably, the diameter and the radius of the lens of the further light guide are identical or substantially identical to the diameter and the radius of the lens of the light guide.

Preferably, the vacuum cleaner has a plurality of accessories that can be coupled to one another. This means that the accessories can be coupled not only to the hand-held part, but also to one another. Each of the plurality of accessories preferably has its own further light guide. The plurality of accessories are preferably identical or substantially identical in relation to the further light guide so that, when one of the plurality of accessories is coupled to the hand-held part and to another one of the accessories, the light guide forms a light guide system with the further light guides.

In a preferred embodiment, the light source is designed as an LED (light-emitting diode). A light-emitting diode has low energy consumption and a long service life.

### BRIEF DESCRIPTION OF THE DRAWINGS

An exemplary embodiment of the disclosure is shown purely schematically in the drawings and is described in more detail below. Schematically and not to scale in the drawings:

FIG. 1 is a side view of a vacuum cleaner according to the disclosure;

FIG. 2 is an enlarged partial side view of the vacuum cleaner shown in FIG. 1;

FIG. 3 is an enlarged partial side view of the light guide shown in FIG. 2;

FIG. 4 is a partial side view of the light guide shown in FIG. 3;

FIG. 5 is a further enlarged partial side view of the vacuum cleaner shown in FIG. 1;

FIG. 6 is an enlarged side view of the light guide and further light guide shown in FIG. 5; and

FIG. 7 is a side view of a variant of the vacuum cleaner shown in FIG. 1.

### DETAILED DESCRIPTION OF THE DRAWINGS

FIG. 1 is a side view of a vacuum cleaner according to the disclosure. The vacuum cleaner according to the disclosure has a hand-held part 1 which can be gripped and held by hand by a user of the vacuum cleaner during operation. The hand-held part has a light source 2 and a light guide 3. The hand-held part 1 combines all the vacuum cleaner components necessary for vacuuming and can be used independently for vacuuming. The vacuum cleaner furthermore comprises at least one accessory 4 which is able to be coupled to the hand-held part 1 and is shown coupled in FIG. 1. The hand-held part 1 is coupled to the accessory 4 by means of a connecting portion 6 via a plug connection. Preferably, the connecting portion 6 is designed such that the hand-held part 1 and the accessory can only be positioned in one position relative to each other. The accessory has an additional light guide (not shown) and is designed by way of example as a nozzle. The light guide 3 has a lens-shaped surface so that it functions as a light output body during operation when the hand-held part 1 and the accessory 4 are uncoupled, and functions as a light coupling point for the further light guide when the hand-held part 1 and the accessory 4 are coupled.

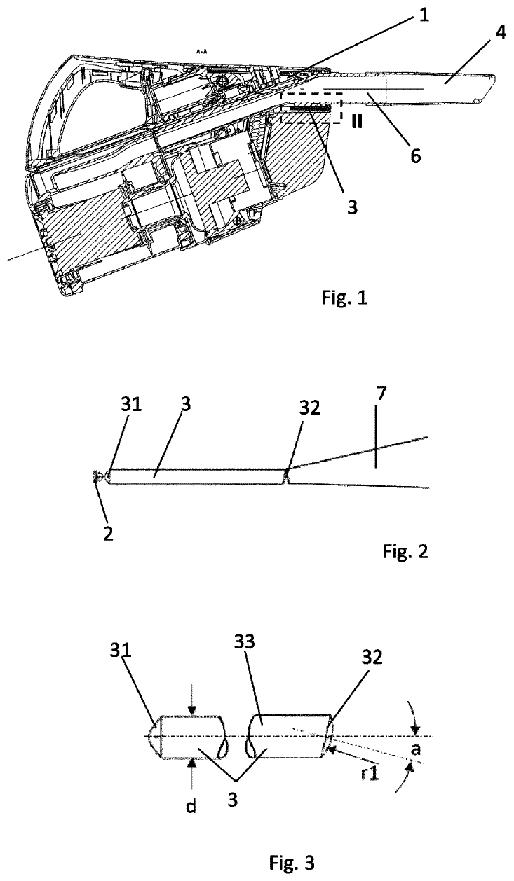

FIG. 2 is an enlarged partial side view of the vacuum cleaner shown in FIG. 1. Shown are the light guide 3 and a light source 2 associated therewith. The light guide 3 is designed with a circular cross section. It has an incoupling optic 31 and an outcoupling optic 32. The incoupling optic 31 and the outcoupling optic 32 are each designed as lenses. Each of the two lenses is convex. The lens of the outcoupling optic 32 is inclined relative to an optical axis (not shown) of the light guide 3. Furthermore, a light cone 7 is shown, which couples out of the outcoupling optic 32. The light beam exits non-symmetrically, i.e., asymmetrically to the light guide 3.

FIG. 3 is an enlarged partial side view of the light guide 3 shown in FIG. 2, wherein a central part is omitted for clarity, as indicated by the breaking lines. The lens of the outcoupling optic 32 is inclined at its light output surface relative to the optical axis 33 of the light guide 3 at a predetermined angle a. The predetermined angle a is, for example, 12°. The light guide 3 has a diameter d of 4 mm, for example. The lens of the outcoupling optic 32 has a radius r1, which is 4 mm, for example.

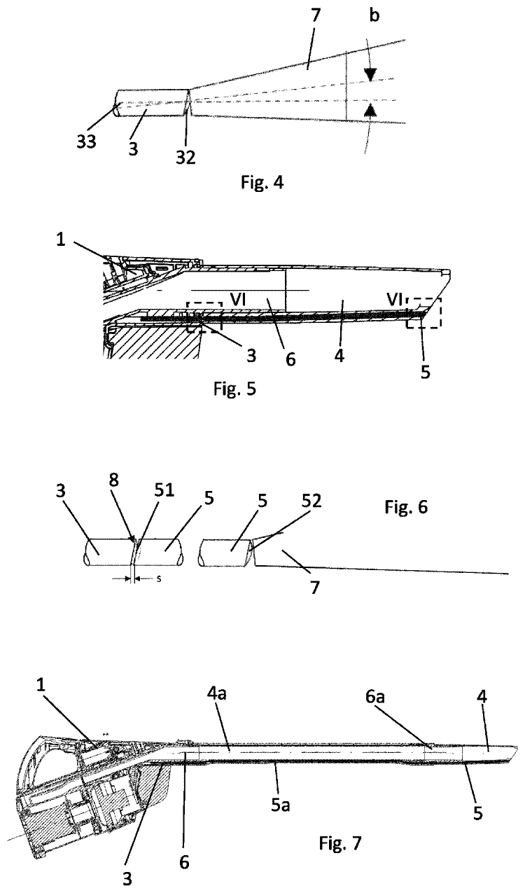

FIG. 4 is a partial side view of the light guide shown in FIG. 3. Shown is the light guide 3 with its outcoupling optic 32 and a light cone 7 coupled out of the outcoupling optic 32. As already described, the outcoupling optic 32 has a convex lens with a radius (not shown) of 4 mm, which is inclined by 12° relative to the optical axis of the light guide 3. This results in an inclination b of the light cone 7 or light cone relative to the optical axis 33 of the light guide 3 of approximately 18°.

FIG. 5 is a further enlarged partial side view of the vacuum cleaner shown in FIG. 1. Shown is a part of the hand-held part 1 which is coupled to the accessory 4 via the connecting portion 6. The accessory 4 has the further light guide 5. The further light guide 5 does not require its own light source. Rather, the vacuum cleaner has an illumination unit which consists of the light source (not shown) generating the light and the light guide system comprising the light guide 3 and the further light guide 5. The light guide 3 and the further light guide 5 are designed and arranged relative to each other in such a way that light coupled out of the light guide 3 is coupled into the further light guide 5.

FIG. 6 is an enlarged side view of the light guide and further light guide shown in FIG. 5, wherein parts of the light guide and the further light guide are omitted for clarity, as indicated by the breaking lines. The further light guide 5 has a further incoupling optic 51 and a further outcoupling optic 52, wherein the incoupling optic is designed as a concave lens and the outcoupling optic is designed as a convex lens. The further light guide 5 has the same diameter as the light guide 3. The lens of the further incoupling optic 51 is designed as a negative form of the lens of the outcoupling optic 32, and the lens of the further outcoupling optic 52 is designed to be the same as the lens of the outcoupling optic 32. A distance s between the lens of the outcoupling optic 32 and the lens of the further incoupling optic 51 is less than 0.5 mm. A conical light cone 7 is coupled out of the further outcoupling optic 52.

FIG. 7 is a side view of a variant of the vacuum cleaner shown in FIG. 1. The vacuum cleaner has a plurality of accessories 4, 4a. FIG. 7 shows the vacuum cleaner according to FIG. 1, in which an accessory 4a in the form of an extension tube is arranged between the hand-held part 1 and the accessory 4. The hand-held part 1 is coupled via the connecting portion 6 to the accessory 4a, which in turn is coupled to the accessory 4 by means of a connecting portion 6a via a plug connection. The accessory 4a also has a further light guide 5a, which is designed correspondingly to the further light guide 5 so that it forms the light guide system together with the light source 2, the light guide 3 and the light guide 5.

### List of Reference Signs

A angle
B inclination
d diameter
r1 radius
S distance
1 hand-held part
2 light source
3 light guide
31 incoupling optic
32 outcoupling optic
33 optical axis
4, 4a accessory
5, 5a further light guide
51 further incoupling optic
52 further outcoupling optic
6, 6a connecting portion
7 light cone
8 light interface

1. A vacuum cleaner with a hand-held part, having a light source and a light guide, and at least one accessory which is able to be coupled to the hand-held part and has a further light guide, wherein the light guide has a lens-shaped surface such that, during operation, it functions as a light output body when the hand-held part and the at least one accessory are uncoupled, and functions as a light coupling site for the further light guide when the hand-held part and the at least one accessory are coupled.

2. The vacuum cleaner according to claim 1, wherein the light guide has an incoupling optic and an outcoupling optic, which are each configured as lenses.

3. The vacuum cleaner according to claim 2, wherein the lenses are convex.

4. The vacuum cleaner according to claim 2, wherein the lens of the outcoupling optic is inclined at its light output surface relative to an optical axis of the light guide at the predetermined angle, wherein the predetermined angle is in the range of 10 to 14°.

5. The vacuum cleaner according to claim 4, wherein the light guide has a diameter and the lens of the outcoupling optic has a radius that substantially corresponds to the diameter, wherein the diameter and the radius are each in the range of 2 to 6 mm.

6. The vacuum cleaner according to claim 2, wherein the lens of the incoupling optic is parabolic or spherical and/or that the lens of the outcoupling optic is spherical.

7. The vacuum cleaner according to claim 2, wherein the further light guide has a further incoupling optic and a further outcoupling optic, which are each designed as lenses, wherein the lens of the further incoupling optic is designed as a negative form of the lens of the outcoupling optic and the lens of the further outcoupling optic is designed to be the same or substantially the same as the lens of the outcoupling optic.

8. The vacuum cleaner according to claim 7, wherein a distance between the lens of the outcoupling optic and the lens of the further incoupling optic is less than 0.5 mm when the hand-held part is coupled to the at least one accessory.

9. The vacuum cleaner according to claim 1, wherein the vacuum cleaner has a plurality of accessories which can be coupled to one another.

10. The vacuum cleaner according to claim 1, wherein the light source configured as an LED.
